(19) United States
(12) Patent Application Publication
(10) Pub. No.: US 2012/0081210 A1
(43) Pub. Date: Apr. 5, 2012

(54) PORTABLE ELECTRONIC DEVICE AND RECORDING MEDIUM

(75) Inventors: Kenji WATANABE, Kawasaki (JP); Nana Ueno, Kawasaki (JP); Tatsuya Hiraishi, Kawasaki (JP); Masashi Sanjo, Kawasaki (JP)

(73) Assignee: FUJITSU LIMITED, Kawasaki-shi (JP)

(21) Appl. No.: 13/233,742

(22) Filed: Sep. 15, 2011

(30) Foreign Application Priority Data
Oct. 5, 2010 (JP) 2010-225702

(51) Int. Cl. H04Q 5/22

(52) U.S. Cl. 340/10.1

(57) ABSTRACT

A portable electronic device having a power supply unit and an IC chip that conducts wireless communication with a reader/writer and operates when power is supplied from the power supply unit includes a first determining unit that determines whether or not the portable electronic device, in a state in which the IC chip is operating moved, according to a result of detection by a sensor to detect movement, a second determining unit that determines whether or not a signal from an opposing device equipped with the reader/writer was received, and a power control unit that conducts control to allow a state in which power is supplied to the IC chip from the power supply unit when the first determining unit determines that the portable electronic device did not move and the second determining unit determines that the signal was received.

### CROSS-REFERENCE TO RELATED APPLICATIONS

This application is based upon and claims the benefit of priority of the prior Japanese Patent Application No. 2010-225702, filed on Oct. 5, 2010, the entire contents of which are incorporated herein by reference.

### FIELD

The embodiment discussed herein is related to a portable electronic device and a recording medium.

### BACKGROUND

RFID (radio frequency identification) technology that conducts the transfer of ID (identification) information using wireless communication across a short distance between reader/writers (R/W) is generally well known in the art. Frequently, an RFID integrated circuit (IC) chip is loaded into an electronic device such as mobile terminal device so that wireless communication can be conducted between reader/writers placed outside the mobile terminal device and other opposing devices. Such wireless communication is not limited to communication between reader/writers and wireless communication is also frequently conducted between mobile terminal devices made up of opposing mobile terminal devices loaded with RFID IC chips. A mobile terminal device may be, for example, a mobile telephone, a PDA (Personal Digital Assistant), or a portable PC (Personal Computer).

Moreover, mobile terminal devices having RFID IC chips are known to supply power to an RFID IC chip from an internal power supply in the mobile terminal device and to provide on/off control of the power supply to prevent fraudulent use of the RFID IC chip by a third person. For example, a mobile terminal device may allow the power to be turned on by applying a high voltage to a CE (chip-enable) terminal of the RFID IC chip, or turned off by applying a low voltage to the CE terminal. Turning off the power to the RFID IC chip prevents the fraudulent use of the RFID IC chip by a third party since the RFID IC chip cannot be used. Further, power consumption of the mobile terminal device can be reduced by turning the power off in a situation in which the RFID IC chip is not used. For example, it is conceivable to try to reduce power consumption by stopping the power supply to the RFID IC chip in a mobile terminal device when there is no possibility of wireless communication with an opposing device while the user of the mobile terminal device is sleeping.

Previously setting a timer to stop the power supply during a period of time is known in the art as a specific aspect of stopping the power supply to an RFID IC chip. However, the feature of stopping the power supply to an RFID IC chip under such fixed conditions is not desirable since there may be a case in which power is not being supplied to the RFID IC chip when conducting wireless communication with an opposing device.

To avoid this situation, Japanese Laid-open Patent Publication No. 2007-249751 describes a feature of providing a vibration sensor in a device with an RFID IC chip and determining whether there is a state in which wireless communication can be conducted with an opposing device according to the detection of vibration by the vibration sensor.

### SUMMARY

According to an aspect of the embodiment, a portable electronic device having a power supply unit and an IC chip that conducts wireless communication with a reader/writer and operates when power is supplied from the power supply unit includes a first determining unit that determines whether or not the portable electronic device, in a state in which the IC chip is operating, moved according to a result of detection by a sensor to detect movement, a second determining unit that determines whether or not a signal from an opposing device equipped with the reader/writer was received, and a power control unit that conducts control to allow a state in which power is supplied to the IC chip from the power supply unit when the first determining unit determines that the portable electronic device did not move and the second determining unit determines that the signal was received.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates an overall configuration of a mobile telephone according to the present embodiment.

FIG. 2 is a functional block diagram of a mobile telephone according to the present embodiment.

FIG. 3 is a flow chart illustrating a period when stopping the supply of power to an IC chip with reader/writer operations.

FIG. 4 is a flow chart illustrating a period when starting the supply of power to an IC chip with reader/writer operations.

FIG. 5 is a diagram describing operations of the components of a mobile telephone while power is supplied to an IC chip with reader/writer operations.

FIG. 6 is a diagram describing operations of the components of a mobile telephone when the power supply to an IC chip with reader/writer operations is stopped.

FIG. 7 is a diagram describing operations of the components of a mobile telephone when the power supply to an IC chip with reader/writer operations is started.

### DESCRIPTION OF EMBODIMENTS

Hereinbelow, embodiments of a portable electronic device and a recording medium according to the present invention will be described with reference to the accompanying drawings. The embodiments are not limited to the features disclosed herein. For example, a mobile telephone is used as an example of the electronic device in the present embodiment. However, the technology described herein is not limited to a mobile telephone and an electronic device. For example, a portable PC or PDA and the like, containing an IC chip that conducts communication with an opposing device, may also be applicable. Moreover, the present embodiment describes a reader/writer provided as an example of an opposing device outside of the electronic device. However, the present embodiment is not limited in this way and wireless communication may be conducted between mutual electronic devices as, for example, opposing electronic devices containing RFID IC chips.

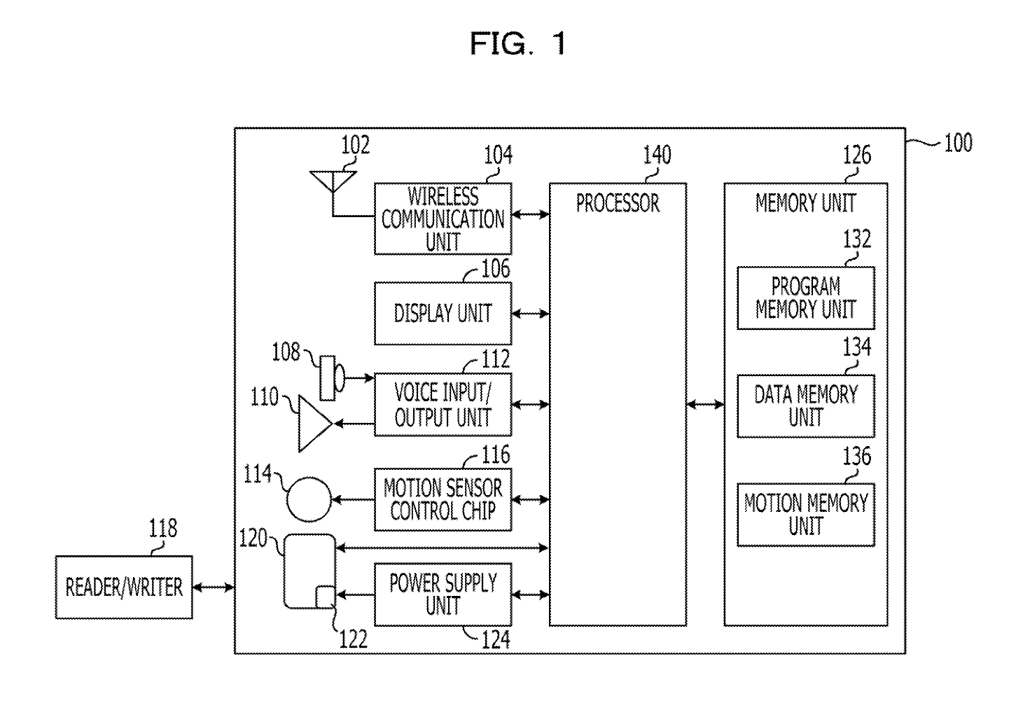

FIG. 1 illustrates an overall configuration of a mobile telephone according to the present embodiment. FIG. 1 illustrates a hardware configuration of a mobile telephone according to the present embodiment.

As illustrated in FIG. 1, a mobile telephone 100 of the present embodiment includes a wireless communication unit 104, a display unit 106, a voice input/output unit 112, a motion sensor control chip 116, a reader/writer operation enabled IC chip 120, a power supply unit 124, a memory unit 126, and a processor 140.

The wireless communication unit 104 conducts wireless communication of data such as voice and text through an antenna 102 provided on the mobile telephone 100. The display unit 106 is an input/output interface that displays information such as text and images. The voice input/output unit 112 is an input/output interface that inputs audio through a microphone 108 provided on the mobile telephone 100, and outputs audio through a speaker 110 also provided on the mobile telephone 100. The motion sensor control chip 116 inputs detection signals detected by a motion sensor 114 loaded onto the mobile telephone 100. Specifically, the motion sensor control chip 116 inputs detection signals that indicate motion of the mobile telephone 100 based on the motion sensor 114. The motion sensor 114 is a three dimensional acceleration sensor using, for example, a capacitance detection method or a piezoresistance method. However, the mobile telephone 100 may be equipped with, for example, a tilt sensor, a vibration sensor, or another type of sensor that detects movement of the mobile telephone 100 without being limited to the above-mentioned motion sensor 114. Moreover, the mobile telephone 100 may be equipped with an illumination sensor that detects ambient light or darkness intensity around the mobile telephone 100 without being limited to the above-mentioned motion sensor 114. For example, a low light intensity may be detected by the illumination sensor in the mobile telephone 100 while the user is sleeping or when the mobile telephone 100 is inserted into a pocket of the user. Therefore, when the light intensity is detected as low by the illumination sensor, the mobile telephone 100 can detect that the mobile telephone 100 is not in a condition to be used for conducting wireless communication. Moreover, when the light intensity is detected as high, the mobile telephone 100 can detect that the mobile telephone 100 is in a condition to be used for conducting wireless communication. The reader/writer operation enabled IC chip 120 is an RFID IC chip that conducts communication with a reader/writer 118 outside of the mobile telephone 100. The power supply unit 124 supplies electric power to a power supply terminal 122 of the IC chip 120.

The memory unit 126 includes a program memory unit 132 that stores programs for conducting various functions of the mobile telephone 100 such as telephone functions, display functions and communication functions with the reader/writer 118. The memory unit 126 also includes a data memory unit 134 that stores, for example, data such as a user telephone directory and telephone history. The data memory unit 134 may be, for example, a random access memory (RAM). The memory unit 126 also includes a motion memory unit 136 that stores detection signals detected by the motion sensor 114 related to the movement of the mobile telephone 100. Specifically, a history of the movements of the mobile telephone 100 for each time movement of the mobile telephone 100 that is detected by the motion sensor 114 is stored in the motion memory unit 136.

The processor 140 is a central processing unit (CPU) that uses the data stored in the data memory unit 134 and the motion memory unit 136 to conduct the programs stored in the program memory unit 132. The processor 140 controls the above-mentioned wireless communication unit 104, the display unit 106, the voice input/output unit 112, the motion sensor control chip 116, the reader/writer operation enabled IC chip 120, and the power supply unit 124 by conducting the programs stored in the program memory unit 132.

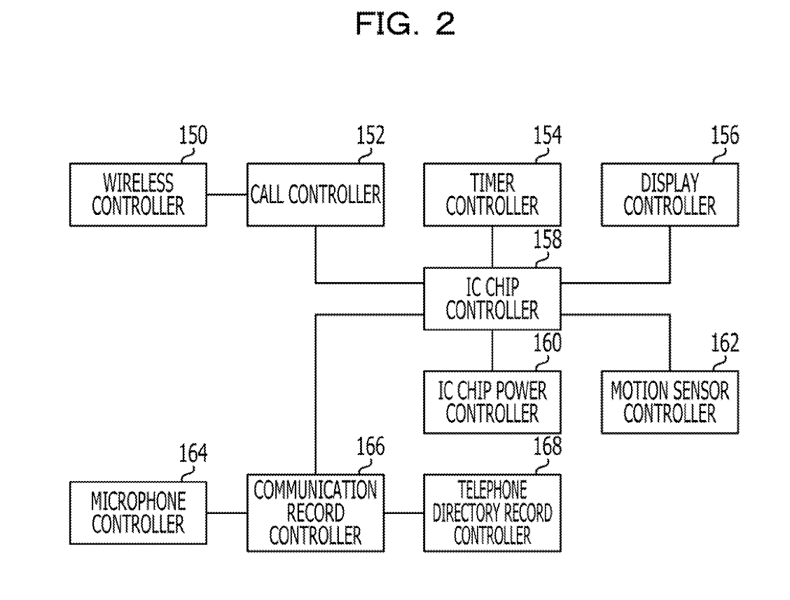

FIG. 2 is a functional block diagram of the mobile telephone 100 according to the present embodiment. FIG. 2 illustrates functional blocks that are achieved by programs executed by the processor 140. The mobile telephone 100 includes a wireless controller 150, a call controller 152, a timer controller 154, a display controller 156, an IC chip controller 158, an IC chip power controller 160, a motion sensor controller 162, a microphone controller 164, a communication record controller 166, and a telephone directory record controller 168 as function blocks.

The wireless controller 150 controls wireless communication of data such as voice and text by controlling the wireless communication unit 104. The call controller 152 controls by connecting or cutting off a line for communication with the mobile telephone of a communication partner. The microphone controller 164 conducts control related to the input and output of audio sensed by the microphone 108. The communication record controller 166 controls the storage of user communication records in the data memory unit 134. The telephone directory record controller 168 controls the storage of the telephone directory inputted by the user in the data memory unit 134. The display controller 156 controls displaying by the display unit 106 of information such as text and images stored in the data memory unit 134. The motion sensor controller 162 stores detection signals of the movement of the mobile telephone 100 detected by the motion sensor 114 and inputted by the motion sensor control chip 116, in the motion memory unit memory unit 136.

The IC chip controller 158 determines the presence of wireless signals sent from the reader/writer 118 when movement of the mobile telephone 100 is not detected by the motion sensor 114. Specifically, the IC chip controller 158 sends an access signal to the reader/writer 118 and determines the presence of a response signal sent by the reader/writer 118 in response to the access signal when movement of the mobile telephone 100 is not detected by the motion sensor 114. The IC chip controller 158 determines whether the reader/writer 118 is located inside a region where wireless communication is possible based on the presence of the response signal. Specifically, the IC chip controller 158 periodically refers to the motion memory unit 136 in certain time intervals to determine whether a history of movements of the mobile telephone 100 during a certain time period has been stored. The IC chip controller 158 determines that the mobile telephone 100 is not moving when no movement of the mobile telephone 100 is detected even once by the motion sensor 114 during a certain time period. The IC chip controller 158 sends the access signal to the reader/writer 118 when no movement of the mobile telephone 100 is detected even once by the motion sensor 114 during a certain time period. The IC chip controller 158 determines whether the reader/writer 118 is located in a region where wireless communication is possible based on sending an access signal and the presence of the response signal sent by the reader/writer 118 in response to the access signal. Details of the IC chip controller 158 are described below.

The IC chip power controller 160 stops or starts a power supply from the power supply unit 124 to the reader/writer operation enabled IC chip 120 according to a result of the determination of whether the reader/writer 118 is located inside a wireless communicable region by the IC chip controller 158. That is, the IC chip power controller 160 stops the supply of power to change the condition of supplying power to the reader/writer operation enabled IC chip 120 according to a command signal sent by the IC chip controller 158. Further, the IC chip power controller 160 starts the supply of power to change the condition of not supplying power to the reader/writer operation enabled IC chip according to a command signal sent by the IC chip controller 158. For example, the IC chip power controller 160 starts the supply of power by applying a high voltage to a CE (chip-enable) terminal of the RFID IC chip, or turns off the supply of power by applying a low voltage to the CE terminal. The timer controller 154 measures the passage of time when determining whether the power is supplied to the reader/writer operation enabled IC chip 120 by the IC chip controller 158.

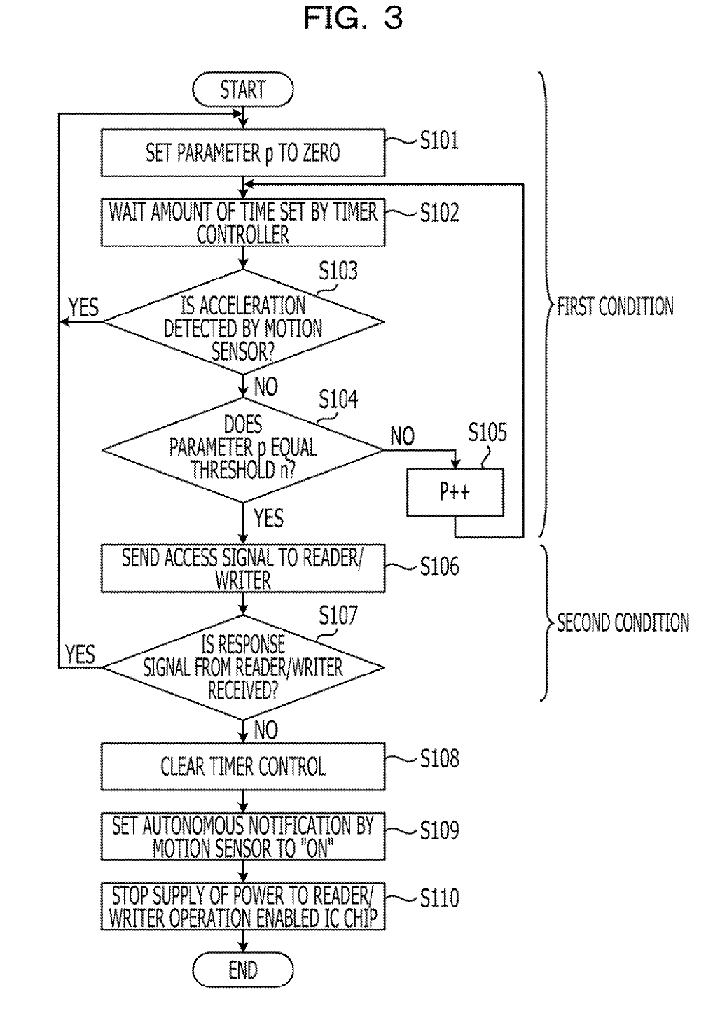

FIG. 3 is a flow chart illustrating the stoppage of the supply of power to an IC chip with reader/writer operations. First, the IC chip controller 158 sets a parameter p for counting the number of times movement of the mobile telephone 100 is not detected by the motion sensor 114 to “0” (step S101). Next, the IC chip controller 158 waits a certain amount of time previously set by the timer controller 154 (step S102). Next, the IC chip controller 158 determines whether or not movement of the mobile telephone 100 is detected by the motion sensor 114 (step S103). If movement of the mobile telephone 100 is detected (step S103 Yes), the IC chip controller 158 returns to step S101.

That is, a first condition in which communication between the mobile telephone 100 and the reader/writer 118 is possible may be a case where the user holds the mobile telephone 100 so that a data transfer face of the mobile telephone 100 is close to a data transfer face of the reader/writer 118. Detection of movement of the mobile telephone 100 indicates that there is a probability that the user holds the mobile telephone 100 close to the data transfer face of the reader/writer 118 since it can be assumed that the mobile telephone 100 is being carried and moved by the user. As a result, the IC chip controller 158 continues to supply power to the reader/writer operation enabled IC chip 120 without stopping the supply of power.

If movement of the mobile telephone 100 is not detected (step S103 No), the IC chip controller 158 determines whether or not the value of the parameter p has reached a threshold n (step S104). Herein, “n” is a natural number. If the parameter p has not reached the threshold n (step S104 No), the IC chip controller 158 increments the value of the parameter p (step S105) and returns to step S102.

That is, instead of the IC chip controller 158 determining that the mobile telephone 100 is stationary when movement of the mobile telephone 100 is not detected only once, the IC chip controller 158 determines that the mobile telephone 100 is stationary when movement is not detected n number of times continuously during a certain time period. In this way, the IC chip controller 158 determines whether or not the mobile telephone 100 is stationary as the first condition for stopping the supply of power to the reader/writer operation enabled IC chip 120 according to the steps S101 to S105.

If the value of the parameter p has reached the threshold n (step S104 Yes), the IC chip controller 158 sends an access signal to the reader/writer 118 (step S106). Next, the IC chip controller 158 confirms the receipt of a response signal from the reader/writer 118 in response to the access signal (step S107). Steps S106 and S107 become a second condition for stopping the supply of power to the reader/writer operation enabled IC chip 120. If receipt of the response signal from the reader/writer 118 is confirmed (step S107 Yes), the IC chip controller 158 returns to step S101.

That is, the second condition in which communication between the mobile telephone 100 and the reader/writer 118 is possible may be assumed when conducting communication with the reader/writer 118 while the mobile telephone 100 is stationary. For example, a second condition in which the mobile telephone 100 is placed on the reader/writer 118 such that the data transfer face of the mobile telephone 100 and the data transfer face of the reader/writer 118 are facing each other while the reader/writer 118 is operating, may be considered. Additionally, a second condition in which the reader/writer 118 is located in the wireless communicable region while the mobile telephone 100 is stationary may also be considered. In the second condition, the reader/writer 118 can conduct communication even when the mobile telephone 100 is in a stationary state. Hence, when it is determined that the mobile telephone 100 is in the stationary state, the IC chip controller 158 confirms whether or not communication is being conducted between the mobile telephone 100 and the reader/writer 118 in the second condition without stopping the supply of power to the reader/writer operation enabled IC chip 120. Specifically, the IC chip controller 158 determines whether or not the reader/writer 118 is located inside the wireless communicable region. More specifically, the IC chip controller 158 determines that communication can be conducted in the second condition when the access signal is sent to the reader/writer 118 and the response signal is received from the reader/writer 118 in response to the access signal. As a result, the IC chip controller 158 continues to supply power to the reader/writer operation enabled IC chip 120 without stopping the supply of power.

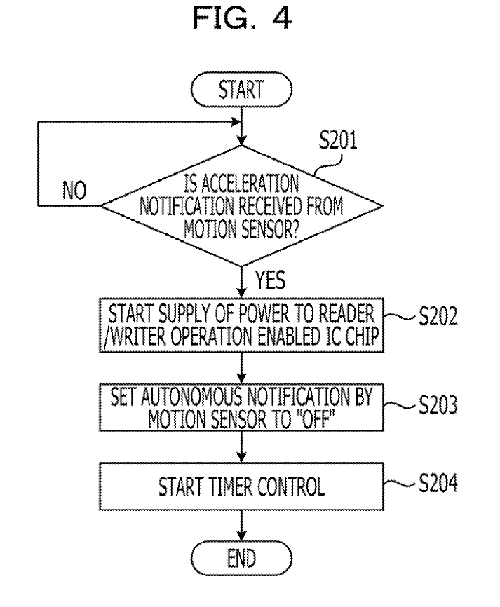

On the other hand, if the response signal is not received (step S107 No), the IC chip controller 158 clears the timer control by the timer controller 154 (step S108) and sets autonomous notification of the motion sensor 114 to “on” (step S109). As a result, instead of detecting movement of the mobile telephone 100 for certain time periods previously set by the timer controller 154, the motion sensor 114 autonomously and continually checks for movement of the mobile telephone 100. Next, the IC chip controller 158 stops the supply of power to the reader/writer operation enabled IC chip 120 (step S110). Specifically, the IC chip controller 158 sends a signal to the IC chip power controller 160 to request the stoppage of the power supply. When the IC chip power controller 160 receives the signal requesting the stoppage of the power supply, the IC chip power controller 160 stops the supply of power from the power supply unit 124 to the reader/writer operation enabled IC chip 120. After ending the control of the stoppage of power to the reader/writer operation enabled IC chip 120, the IC chip controller 158 switches the control to the process for starting the supply of power to the reader/writer operation enabled IC chip 120 as described in FIG. 4.

FIG. 4 is a flow chart illustrating the start of the supply of power to the reader/writer operation enabled IC chip 120. The IC chip controller 158 checks for movement of the mobile telephone 100 based on the motion sensor 114 until movement of the mobile telephone 100 is detected by the motion sensor 114 (step S201). When movement of the mobile telephone 100 is detected by the motion sensor 114 (step S201 Yes), the IC chip controller 158 starts the supply of power to the reader/writer operation enabled IC chip 120 (step S202). Specifically, the IC chip controller 158 sends a signal to the IC chip power controller 160 to request the start of the power supply. When the IC chip power controller 160 receives the signal requesting the start of the power supply, the IC chip power controller 160 starts the supply of power from the power supply unit 124 to the reader/writer operation enabled IC chip 120.

The IC chip controller 158 turns the motion sensor 114 autonomous notification “off” (step S203) and starts the timer control (step S204). As a result, instead of autonomously and continually checking for movement of the mobile telephone 100, the motion sensor 114 checks for movement of the mobile telephone 100 in certain periods of time previously set by the timer controller 154. After ending the control of the start of power to the reader/writer operation enabled IC chip 120, the IC chip controller 158 switches the control to the process for stopping the supply of power to the reader/writer operation enabled IC chip 120 as described in FIG. 3.

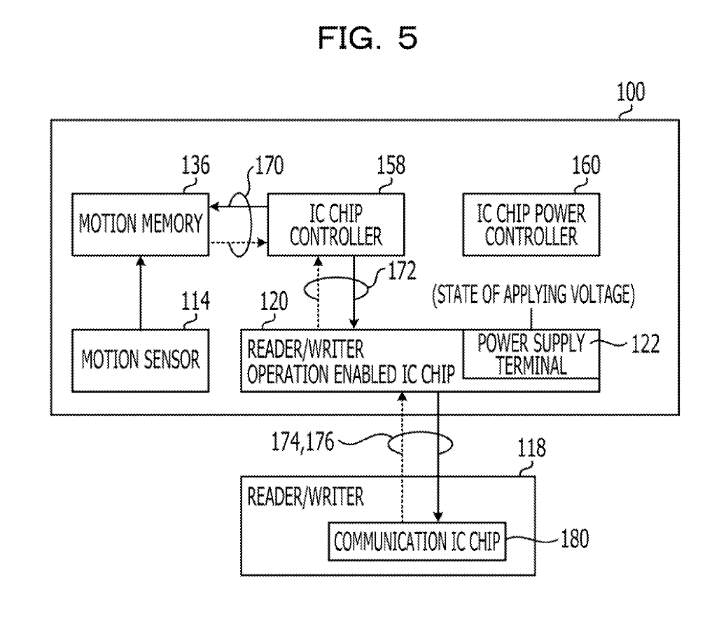

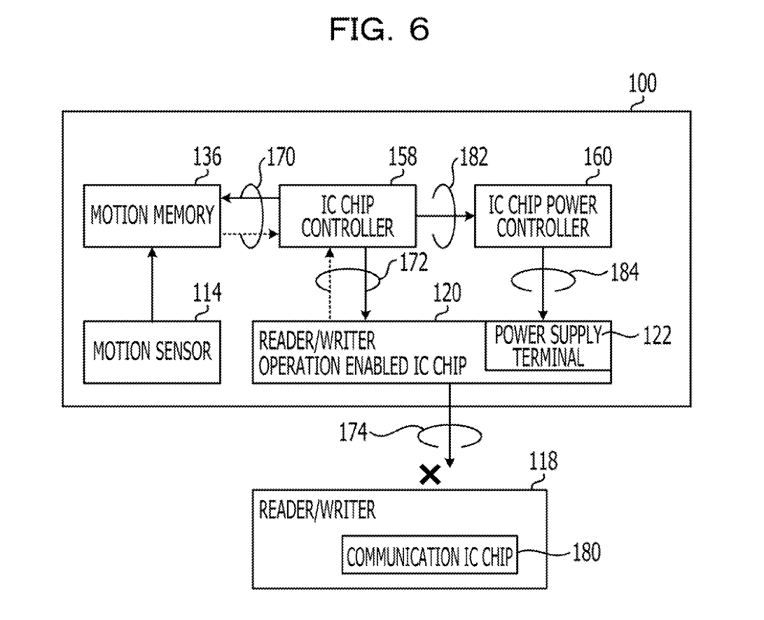

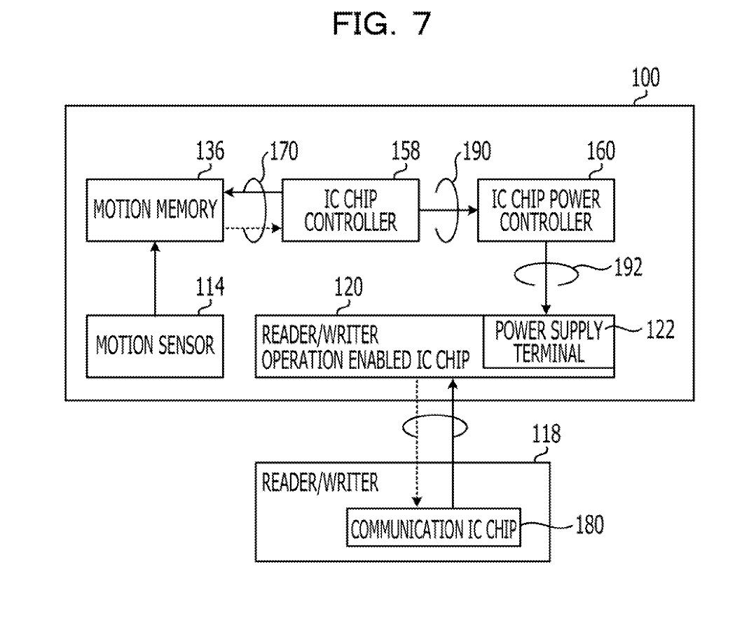

FIG. 5 is a diagram describing operations of the components of the mobile telephone 100 while power is supplied to the reader/writer operation enabled IC chip 120. FIG. 5 illustrates an example of continuing to supply power to the reader/writer operation enabled IC chip 120 to be able to conduct communication between the mobile telephone 100 and the reader/writer 118 under the second condition. FIG. 6 is a diagram describing operations of the components of the mobile telephone 100 while the power supply to the reader/writer operation enabled IC chip 120 is stopped. FIG. 7 is a diagram describing operations of the components of the mobile telephone 100 when the power supply to the reader/writer operation enabled IC chip 120 is started. The FIGS. 5 to 7 illustrate only the components related to the on/off control of the supply of power to the reader/writer operation enabled IC chip 120 among the functional blocks and the hardware configuration of the mobile telephone 100.

As illustrated in FIG. 5, the IC chip controller 158 sends a confirmation signal 170 to the motion memory unit 136 to access the motion memory unit 136 and read a detection signal indicating detection by the motion sensor 114 for confirming movement of the mobile telephone 100. The IC chip controller 158 determines whether or not the mobile telephone has moved based on the read detection signal. In this case, the IC chip controller 158 determines that the mobile telephone 100 is stationary. Next, the IC chip controller 158 sends an access command 172 to the reader/writer operation enabled IC chip 120 to send an access signal to the reader/writer 118. The reader/writer operation enabled IC chip 120 sends an access signal 174 to the reader/writer and receives a response signal 176 in response to the access signal 174.

In this case, the IC chip controller 158 determines that communication is possible even though the mobile telephone 100 is stationary and that the reader/writer 118 is located in the communicable region since the response signal 176 is received from the reader/writer 118. Therefore, the IC chip controller 158 does not send any command to the IC chip power controller 160 and continues to supply power to the reader/writer operation enabled IC chip 120. The response signal 176 from the reader/writer 118 is sent by a communication IC chip 180 provided in the reader/writer 118.

As illustrated in FIG. 6, the IC chip controller 158 sends the confirmation signal 170 to the motion memory unit 136 to read the detection signal indicating detection by the motion sensor 114 for confirming movement of the mobile telephone 100. The IC chip controller 158 determines whether or not the mobile telephone has moved based on the read detection signal. In this case, the IC chip controller 158 determines that the mobile telephone 100 is stationary. Next, the IC chip controller 158 sends an access command 172 to the reader/writer operation enabled IC chip 120 to send an access signal 174 to the reader/writer 118. The reader/writer operation enabled IC chip 120 sends the access signal 174 to the reader/writer 118.

In this case, the IC chip controller 158 determines that the mobile telephone 100 is stationary and that the reader/writer is not located in the communicable region since a response signal is not received from the reader/writer 118. That is, the IC chip controller 158 determines that the current condition is not a condition in which communication can be conducted by the mobile telephone 100. Therefore, the IC chip controller 158 sends a stoppage request signal 182 to the IC chip power controller 160 to stop the supply of power. After receiving the stoppage request signal 182, the IC chip power controller 160 sends a stoppage signal 184 for stopping the supply of power to the reader/writer operation enabled IC chip 120 to stop the supply of power to the reader/writer operation enabled IC chip 120.

Next, as illustrated in FIG. 7, the IC chip controller 158 sends the confirmation signal 170 to the motion memory unit 136 to read the detection signal indicating detection by the motion sensor 114 for confirming movement of the mobile telephone 100. The IC chip controller 158 determines whether or not the mobile telephone has moved based on the read detection signal. In this case, the IC chip controller 158 determines that the mobile telephone 100 has moved. Therefore, the IC chip controller 158 sends a start request signal 190 to the IC chip power controller 160 to start the supply of power. After receiving the start request signal 190, the IC chip power controller 160 sends a start signal 192 for starting the supply of power to the reader/writer operation enabled IC chip 120 to start the supply of power to the reader/writer operation enabled IC chip 120.

As described above, the mobile telephone 100 of the present embodiment determines whether or not the mobile telephone 100 is stationary as the first condition, and also determines whether or not the reader/writer 118 is located in the communicable region as the second condition. Specifically, when it is determined that the mobile telephone 100 is stationary and the reader/writer 118 is not located in the communicable region by determining both the first and the second condition in order, the mobile telephone 100 stops the supply of power to the reader/writer operation enabled IC chip 120. The second condition is determined based on whether or not a response signal is obtained when an access signal is sent to the reader/writer 118.

Therefore, according to the mobile telephone 100 of the present embodiment, the possibility of falsely determining a condition in which communication cannot be conducted can be reduced regardless of whether or not the mobile telephone 100 and the reader/writer 118 are in a condition in which communication is possible. For example, communication may be conducted between the mobile telephone 100 and the reader/writer 118 due to operation by the reader/writer 118 in the condition in which the mobile telephone 100 is placed on the data transfer face of the reader/writer 118. In this case, there is a possibility of falsely determining that communication between the mobile telephone 100 and the reader/writer 118 can be conducted if the mobile telephone 100 only determines the first condition since movement of the mobile telephone 100 is not detected. Conversely, the mobile telephone 100 of the present embodiment can appropriately determine whether or not communication between the mobile telephone 100 and the reader/writer 118 is possible by determining both the first and the second conditions. As a result, the mobile telephone 100 of the present embodiment can implement reliable operations in the condition in which wireless communication with the reader/writer 118 can be conducted. Moreover, the mobile telephone 100 of the present embodiment can reduce power consumption by being able to stop the supply of power to the reader/writer operation enabled IC chip 120 only in the condition in which the mobile telephone 100 can conduct communication with the reader/writer 118.

The mobile telephone 100 of the present embodiment can also spontaneously send an access signal to determine whether or not the reader/writer 118 is located in a communicable region. The techniques disclosed in Japanese Laid-open Patent Publication No. 2007-249751 includes continuously sending an access signal from the reader/writer 118 and determining that communication with the reader/writer 118 can be conducted after the mobile terminal device has received the access signal. This technique may be applicable to, for example, a dedicated reader/writer with an RFID IC chip tag and provided on a cargo conveyance path. However, this technique is difficult to achieve since various types of reader/writers that can conduct wireless communication with a mobile terminal device may not have a function to continuously send access signals. However, the mobile telephone 100 of the present embodiment determines whether or not the reader/writer 118 is located in a communicable region by spontaneously sending an access signal instead of waiting for the reader/writer 118 to send an access signal.

Moreover, the mobile telephone 100 of the present embodiment continuously determines the first condition indicating whether or not the mobile telephone 100 is stationary and only determines the second condition which indicates whether or not a response signal was obtained in response to sending an access signal to the reader/writer 118 when it is determined that the mobile telephone 100 is stationary. Hence, the mobile telephone 100 of the present embodiment can reduce power consumption by minimizing power consumption caused by sending access signals to the reader/writer 118.

Moreover, the mobile telephone 100 of the present embodiment starts the supply of power to the reader/writer operation enabled IC chip 120 when movement of the mobile telephone 100 is detected by the motion sensor 114. Therefore, the mobile telephone 100 of the present embodiment can control starting the supply of power to the reader/writer operation enabled IC chip 102 with a simple configuration.

The present embodiment is not limited to the above description focusing mainly on an electronic device and a power control method for an electronic device. Additionally, the above-mentioned present embodiment may achieve similar functions by implementing a previously prepared power control program with a computer. That is, the power control program is caused by the computer to conduct a first determining process to determine whether or not an electronic device having an IC chip in an operating state and operating only when wireless communication with a reader/writer can be conducted and power is being supplied from a power supply unit, has moved according to a result of detection conducted by a sensor that detects movement. Further, the power control program is caused by the computer to execute a second determining process to determine whether or not a signal from an opposing device having a reader/writer is received. Further, the power control program is caused by the computer to control the condition of supplying power from the power supply unit to the IC chip when it is determined that the signal is received in the second determining process and when it is determined that the electronic device did not move in the first determining process. The power control program may be distributed to the computer through a communication network such as the internet and the like. Furthermore, the power control program may be recorded on a memory, a hard disk, or another type of computer-readable recording medium provided in the computer so that the program may be executed by being read from the recording medium by the computer.

All examples and conditional language recited herein are intended for pedagogical purposes to aid the reader in understanding the principles of the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A portable electronic device having a power supply unit and an IC chip that conducts wireless communication with a reader/writer and operates when power is supplied from the power supply unit, the device comprising:
a first determining unit that determines whether or not the portable electronic device, in a state in which the IC chip is operating, moved according to a result of detection by a sensor to detect movement;
a second determining unit that determines whether or not a signal from an opposing device equipped with the reader/writer was received; and
a power control unit that conducts control to allow a state in which power is supplied to the IC chip from the power supply unit when the first determining unit determines that the portable electronic device did not move and the second determining unit determines that the signal was received.

2. A computer-readable recording medium storing a power control program that causes a portable electronic device to execute a process comprising:
determining whether or not the portable electronic device, in a state in which an IC chip operates when wireless communication with a reader/writer is being conducted and when power is supplied from a power supply unit, moved according to a result of a detection by a sensor to detect movement;
determining whether or not a signal from an opposing device equipped with the reader/writer was received; and
allowing a state in which power is supplied from the power supply unit to the IC chip when no movement of the electronic device is determined and when reception of the signal is determined.

3. A power control method executed by a portable electronic device having a power supply unit and an IC chip that conducts wireless communication with a reader/writer and operates when power is supplied from the power supply unit, the method comprising:
determining whether or not the portable electronic device, in a state in which the IC chip operates when wireless communication with the reader/writer is being conducted and when power is supplied from the power supply unit, moved according to a result of a detection by a sensor to detect movement;
determining whether or not a signal from an opposing device equipped with the reader/writer was received; and
allowing a state in which power is supplied from the power supply unit to the IC chip when no movement of the electronic device is determined and when reception of the signal is determined.
